(19) United States
(12) Patent Application Publication
(10) Pub. No.: US 2026/0087953 A1
(43) Pub. Date: Mar. 26, 2026

(54) VIRTUAL IMAGE DISPLAY DEVICE AND HEAD-MOUNTED DISPLAY APPARATUS

(71) Applicant: SEIKO EPSON CORPORATION, Tokyo (JP)

(72) Inventor: Toshiyuki NOGUCHI, SHIOJIRI-SHI (JP)

(73) Assignee: SEIKO EPSON CORPORATION, Tokyo (JP)

(21) Appl. No.: 19/336,516

(22) Filed: Sep. 23, 2025

(30) Foreign Application Priority Data
Sep. 25, 2024 (JP) 2024-165998

(51) Int. Cl. G09G 3/00; G02B 27/01

(52) U.S. Cl. CPC G09G 3/002; G02B 27/0172; G02B 2027/011; G02B 2027/0116; G09G 2320/0242; G09G 2320/028

(57) ABSTRACT

A virtual image display device includes display elements that display an image, an optical member on which an image light corresponding to the image is incident, a reflection member that reflects the image light from the optical member, and a display control device as a control device that corrects the image to be displayed by the display elements so as to cancel a distortion of a virtual image projected by the optical member and the reflection member. When adjusting a convergence distance of the virtual image by a convergence distance adjustment amount, that is, convergence adjustment shift amounts with respect to a horizontal direction, the display control device changes a correction amount of the distortion related to the virtual image in conjunction with a conversion shift amount of the image as at least a part of the convergence distance adjustment amount.

The present application is based on, and claims priority from JP Application Serial Number 2024-165998, filed Sep. 25, 2024, the disclosure of which is hereby incorporated by reference herein in its entirety.

### BACKGROUND

### 1. Technical Field

The present disclosure relates to a virtual image display device and a head-mounted display apparatus that enable observation of a virtual image.

### 2. Related Art

A known head-mounted display apparatus includes a display element that displays an image corrected by a control unit, an optical member on which image light corresponding to the image is incident, and a reflection member that reflects the image light from the optical member and projects a virtual image corresponding to the image, wherein the optical member and the reflection member correct a distortion in first directions related to the virtual image, and the control unit corrects the image according to a distortion in second directions intersecting the first directions related to the virtual image (JP-A-2023-151368). JP-A-2023-151368 is an example of the related art.

In JP-A-2023-151368, adjustment of the convergence distance has not been specifically examined. For example, in the device of JP-A-2023-151368, images displayed on a pair of display elements are symmetrically shifted so as to be close to or away from each other in the horizontal direction, a virtual image can be formed at a desired convergence angle. However, according to the method, a distortion may be formed in the virtual image projected by shifting the display images. Further, according to the method, missing occurs in the image due to the shift of the display images on the display elements.

### SUMMARY

A virtual image display device according to an aspect of the present disclosure includes a display element that is configured to display an image, an optical member on which an image light corresponding to the image is incident, a reflection member that is configured to reflect the image light from the optical member to project a virtual image corresponding to the image, and a control device that is configured to correct the image to be displayed by the display element so as to cancel a distortion of the virtual image projected by the optical member and the reflection member. When adjusting a convergence distance of the virtual image by a convergence distance adjustment amount with respect to a horizontal direction, the control device is configured to change a correction amount of the distortion related to the virtual image in conjunction with a conversion shift amount of the image as at least a part of the convergence distance adjustment amount.

A head-mounted display apparatus according to an aspect of the present disclosure includes a first device including the virtual image display device described above, and a second device including the virtual image display device described above, wherein a convergence distance adjustment amount of the first device and a convergence distance adjustment amount of the second device are the same in magnitude and opposite in direction.

### BRIEF DESCRIPTION OF THE DRAWINGS

FIG. 1 is an external perspective view illustrating a mounted state of a head-mounted display apparatus according to an embodiment.

FIG. 2 is a side cross-sectional view illustrating an internal structure of the head-mounted display apparatus.

FIG. 3 illustrates a virtual image formed at an eye side and an original image displayed on a display element.

FIG. 4 illustrates a distortion state of a virtual image formed by correcting distortion in up-down directions by an optical system.

FIG. 5 illustrates settings of a convergence angle in the head-mounted display apparatus.

FIG. 6 is a block diagram illustrating a circuit configuration of the head-mounted display apparatus.

FIG. 7 illustrates a display surface of a right-eye display element.

FIG. 8 illustrates a coordinate system before a distortion conversion and coordinate systems after distortion conversions in a control unit.

FIG. 9 illustrates a coefficient table for coordinate conversion with respect to conversion shift amounts.

FIG. 10 is a block diagram partially illustrating a display control device and the display elements.

FIG. 11 illustrates a correction of chromatic aberration in the optical system of the head-mounted display apparatus.

FIG. 12 illustrates a linear interpolation for gradation adjustment of an image.

FIG. 13 is a flowchart illustrating image processing in the head-mounted display apparatus.

FIG. 14 illustrates an original initial image captured from a user terminal or the like.

FIG. 15 illustrates examples of images before distortion corrections by conversion shifts.

FIG. 16 illustrates examples of images after the distortion corrections by the conversion shifts.

FIG. 17 illustrates virtual images observed by both eyes at convergence distances.

### DESCRIPTION OF EMBODIMENTS

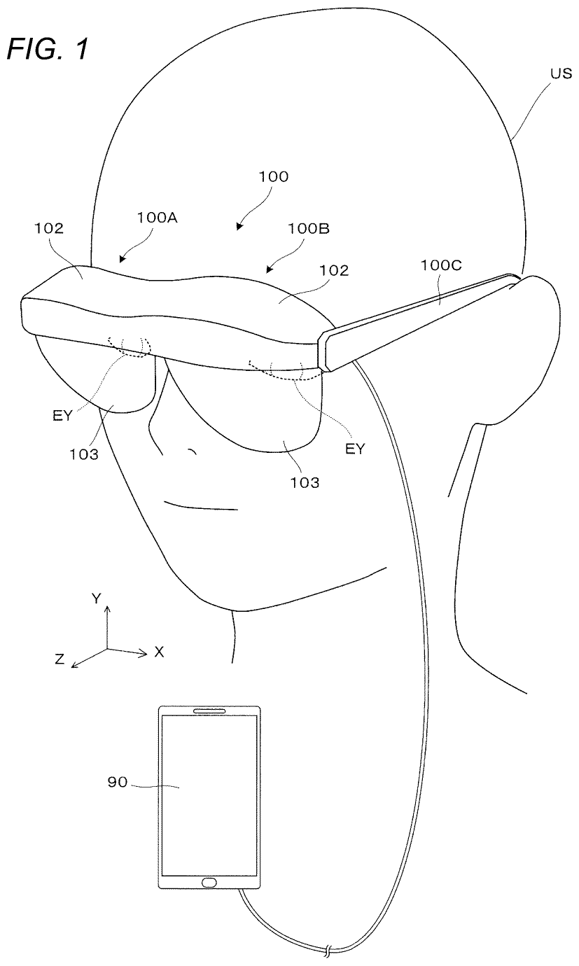

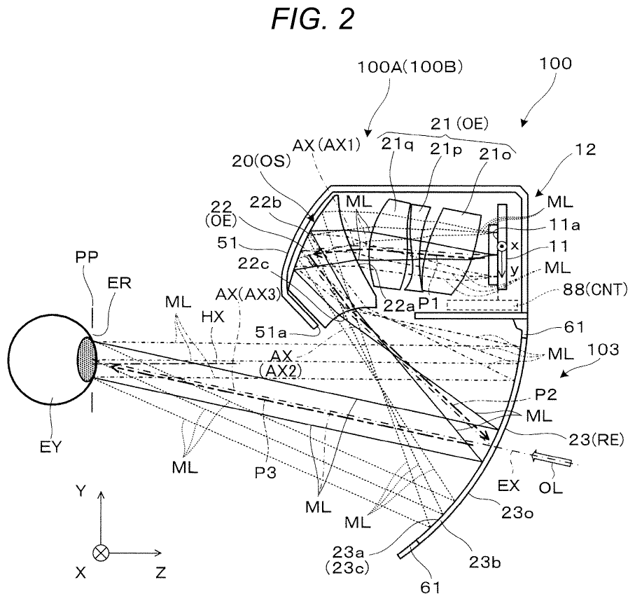

Hereinafter, a virtual image display device and a head-mounted display apparatus according to an embodiment of the present disclosure will be described with reference to FIGS. 1 and 2 and the like.

FIG. 1 illustrates a mounted state of a head-mounted display apparatus or a head-mounted display (hereinafter, also referred to as an HMD) 100, and the head-mounted display apparatus or the HMD 100 causes an observer or a wearer US wearing the head-mounted display apparatus or the HMD to recognize an image as a virtual image. In FIG. 1 and the like, X, Y, and Z form an orthogonal coordinate system, a +X direction corresponds to a lateral direction in which both eyes EY of the observer or the wearer US wearing the HMD 100 are arranged, a +Y direction corresponds to an upward direction orthogonal to the lateral direction in which both eyes EY are arranged with respect to the wearer US, and a +Z direction corresponds to a forward direction or a frontward direction with respect to the wearer US. The +Y directions are parallel to the vertical axis or the vertical direction.

The head-mounted display apparatus 100 includes a first virtual image display device 100A for the right eye, a second virtual image display device 100B for the left eye, a pair of temple-shaped support devices 100C that support the display devices 100A and 100B, and a user terminal 90 that is an information terminal. The first virtual image display device 100A includes a display drive unit 102 disposed in an upper portion and an exterior member 103 that has a spectacle lens shape and covers the front of the eye. Similarly, the second virtual image display device 100B includes a display drive unit 102 disposed in an upper portion and an exterior member 103 having a spectacle lens shape and covering the front of the eye. The support device 100C is a mounting member mounted on the head of the wearer US and supports the upper end side of the exterior member 103 via the display drive unit 102. The first virtual image display device 100A and the second virtual image display device 100B are optically inverted left and right, and the detailed description of the second virtual image display device 100B will be omitted.

FIG. 2 is a side cross-sectional view illustrating an internal structure of the first virtual image display device 100A. The first virtual image display device 100A includes a display element 11, an imaging optical system 20, and a display control device 88. The imaging optical system 20 includes a projection lens 21, a prism mirror 22, and a see-through mirror 23. In the imaging optical system 20, the projection lens 21 and the prism mirror 22 correspond to the display drive unit 102 illustrated in FIG. 1, and the see-through mirror 23 corresponds to the exterior member 103 illustrated in FIG. 1. A combination of the display element 11, the projection lens 21, and the prism mirror 22 is referred to as a projection optical system 12, and these are fixed in a case 51 in alignment with one another. The case 51 is a housing or a support member, is formed using a light-shielding material, and supports the display control device 88 that operates the display element 11. The case 51 has an opening 51a. The opening 51a enables the projection optical system 12 to emit an image light ML toward the outside.

The first virtual image display device 100A corrects a distortion in first directions related to a virtual image by the prism mirror 22 as an optical member OE and the see-through mirror 23 as a reflection member RE. In the present embodiment, for example, the prism mirror 22 and the see-through mirror 23 correct the distortion in the first directions, specifically, in up-down directions related to the virtual image. The first virtual image display device 100A corrects an image or a display image according to a distortion in second directions intersecting the first directions related to the virtual image by the display control device 88. In the present embodiment, for example, the display control device 88 corrects distortions in the lateral directions or the left-right directions inherent in the virtual image by signal processing. Here, the second directions or the left-right directions are directions corresponding to scanning directions of the display element 11. The distortion in the first directions related to the virtual image is no longer present in the first virtual image display device 100A as a result of the correction by the prism mirror 22 and the see-through mirror 23. Further, the remaining distortions inherent in the virtual image are distortions caused by the prism mirror 22 and the see-through mirror 23, are canceled out by the distortion correction in the display control device 88, and are not visually recognized by the eye EY. The projection lens 21 affects the distortion of the virtual image, and the above-described correction is performed by the entire imaging optical system 20 of the first virtual image display device 100A.

The display element 11 is a self-emitting display device. The display element 11 is, for example, an organic EL (Organic Electro-Luminescence) display, and forms a color still: image or moving image on a two-dimensional display surface 11a. The display element 11 is disposed along an xy plane slightly rotated and inclined around the X axis with respect to the XY plane. The display element 11 is driven by the display control device 88 as a control unit to perform display operation. In the example of FIG. 2, the display element 11 is inversely disposed in which a +y direction at the upside of the display element 11 is disposed downward, that is, in the −Y direction with respect to the coordinates of the imaging optical system 20. In this case, due to the inverted characteristics of the imaging optical system 20, the image displayed on the display element 11 has the same directionality of the display content as the original image before correction by the display control device 88.

The display element 11 is not limited to an organic EL display, but can be replaced with a display device using an inorganic EL, an organic LED, an LED array, a laser array, a quantum dot light emitting element, or the like. The display element 11 is not limited to a self-emitting image light generator, but may be an LCD or another light modulator so that an image is formed by illuminating the light modulator by a light source such as a backlight. As the display element 11, an LCOS (Liquid crystal on silicon, registered trademark), a digital micromirror device, or the like may be used instead of the LCD.

In the imaging optical system 20, the projection lens 21 is an optical member OE and includes a first lens 210, a second lens 21p, and a third lens 21q. The projection lens 21 receives the image light ML emitted from the display element 11 and causes the image light to be incident on the prism mirror 22. The projection lens 21 condenses the image light ML emitted from the display element 11 in a state close to a parallel luminous flux. The prism mirror 22 has an incident surface 22a corresponding to an incident portion, an inner reflection surface 22b corresponding to a reflection portion, and an emission surface 22c corresponding to an emission portion. The prism mirror 22 emits the image light ML incident from the front so as to be folded back in a direction inclined with respect to a direction in which the incident direction is reversed (the direction of the light source viewed from the prism mirror 22). The see-through mirror 23 has a reflection surface 23a and an outer surface 230. The see-through mirror 23 enlarges an intermediate image formed at the light emission side of the prism mirror 22.

The imaging optical system 20 is an off-axis optical system OS because the see-through mirror 23 is a concave mirror or the like. In the case of the present embodiment, the projection lens 21, the prism mirror 22, and the see-through mirror 23 are arranged non-axisymmetrically, and have non-axisymmetric optical surfaces. The imaging optical system 20 being the off-axis optical system OS means that, in the optical elements 21, 22, 23 forming the imaging optical system 20, the optical path is bent as a whole before and after incidence of a beam on the plurality of reflection surfaces or refractive surfaces. In the imaging optical system 20, the optical elements 21, 22, 23 are arranged along the off-axis surface by bending an optical axis AX within the off-axis surface parallel to the YZ plane corresponding to the paper surface. The optical axis AX of the imaging optical system 20 includes optical axis portions AX1, AX2, and AX3 that are disposed along the off-axis surface and are inclined with respect to one another before and after the reflection surface. The optical axis AX as a whole is disposed in a Z shape. That is, in the imaging optical system 20, an optical path P1 from the projection lens 21 to the inner reflection surface 22b, an optical path P2 from the inner reflection surface 22b to the see-through mirror 23, and an optical path P3 from the see-through mirror 23 to a pupil position PP are arranged to be folded back twice in the Z shape. The imaging optical system 20 is longitudinally arranged. Correspondingly, the off-axis surface (the surface parallel to the YZ plane) as a reference surface extends parallel to the longitudinal Y direction. In this case, the optical elements 21, 22, 23 forming the first virtual image display device 100A are arranged at different height positions in the longitudinal direction, and thus an increase in the lateral width of the first virtual image display device 100A can be prevented.

In the imaging optical system 20, the optical path P1 from the projection lens 21 to the inner reflection surface 22b extends rearward with reference to the viewpoint in a slightly obliquely upward direction or a direction nearly parallel to the Z direction. The optical path P2 from the inner reflection surface 22b to the see-through mirror 23 extends frontward in an obliquely downward direction. With the horizontal plane direction (XZ plane) as a reference, the inclination of the optical path P2 is larger than the inclination of the optical path P1. The optical path P3 from the see-through mirror 23 to the pupil position PP extends rearward in a slightly obliquely upward direction or a direction nearly parallel to the Z direction. In the illustrated example, the optical axis portion AX3 is at about −10°, which is negative in the downward direction in a view facing the +Z direction. That is, an emission optical axis EX as an extension of the optical axis portion AX3 extends to be inclined downward by about 10° with respect to a center axis HX parallel to the forward +Z direction.

The incident surface and the emission surface of the first lens 210 forming the projection lens 21 are optical surfaces formed of, for example, free-form surfaces, asymmetrical with respect to the longitudinal direction parallel to the YZ plane and intersecting the optical axis AX with the optical axis AX in between, and symmetrical with respect to the lateral direction or the X direction with the optical axis AX in between. The incident surface and the emission surface of the second lens 21p forming the projection lens 21 are optical surfaces formed of, for example, free-form surfaces, asymmetrical with respect to the longitudinal direction parallel to the YZ plane and intersecting the optical axis AX with the optical axis AX in between, and symmetrical with respect to the lateral direction or the X direction with the optical axis AX in between. The incident surface and the emission surface of the third lens 21q forming the projection lens 21 are optical surfaces formed of, for example, free-form surfaces, asymmetrical with respect to the longitudinal direction parallel to the YZ plane and intersecting the optical axis AX with the optical axis AX in between, and symmetrical with respect to the lateral direction or the X direction with the optical axis AX in between.

The prism mirror 22 is an optical member having a refractive reflection function as a function of combining a mirror and a lens, and reflects the image light ML from the projection lens 21 while refracting the image light. Specifically, the prism mirror 22 causes the image light ML to be incident on the inside via the incident surface 22a, totally reflects the incident image light ML in a non-frontward direction by the inner reflection surface 22b, and emits the incident image light ML to the outside via the emission surface 22c. The incident surface 22a, the inner reflection surface 22b, and the emission surface 22c as the optical surfaces forming the prism mirror 22 are optical surfaces formed of, for example, free-form surfaces, asymmetrical with respect to the optical axis AX in the longitudinal direction parallel to the YZ plane and intersecting the optical axis AX, and symmetrical with respect to the optical axis AX in the lateral direction or the X direction. The prism mirror 22 is formed using, for example, a resin, but may be formed using glass. The inner reflection surface 22b is not limited to the surface that reflects the image light ML by total reflection, but may be a reflection surface formed of a metal film or a dielectric multilayer film. In this case, a reflection layer of a single-layer film or a multilayer film formed using a metal such as Al or Ag is formed on the inner reflection surface 22b by vapor deposition or the like, or a sheet-like reflection film formed using a metal is attached thereto.

The see-through mirror 23 is a curved plate-shaped reflective optical member that functions as a concave surface mirror, and reflects the image light ML from the prism mirror 22. That is, the see-through mirror 23 reflects the image light ML from the prism mirror 22 disposed in the emission region of the projection optical system 12 toward the pupil position PP. The see-through mirror 23 covers the pupil position PP at which the eye EY or the pupil is disposed, has a concave shape toward the pupil position PP, and has a convex shape toward the outside. The see-through mirror 23 is a concave transmissive mirror that covers the entire effective region of the screen in the field of view. The see-through mirror 23 is a mirror plate having a structure in which a transmissive mirror film 23c is formed on a front surface or a back surface of a plate-shaped body 23b. The reflection surface 23a of the see-through mirror 23 is, for example, an optical surface formed of a free-form surface, asymmetrical with respect to the longitudinal direction parallel to the YZ plane and intersecting the optical axis AX with the optical axis AX in between, and symmetrical with respect to the lateral direction or the X direction with the optical axis AX in between. The reflection surface 23a of the see-through mirror 23 is, for example, a free-form surface. The see-through mirror 23 is a free-form surface or an aspherical surface, and thus aberration can be reduced. In particular, when a free-form surface is used, it is easy to reduce aberration of the imaging optical system 20 which is the off-axis optical system OS or a non-coaxial optical system.

The see-through mirror 23 is a transmissive reflection element that transmits part of a light at reflection, and the reflection surface 23a or the mirror film 23c of the see-through mirror 23 is formed of a semi-transmissive reflection layer. Accordingly, an external light OL passes through the see-through mirror 23, thereby enabling see-through viewing of the outside and superimposition of the virtual image on an external image. In this regard, when the plate-shaped body 23b supporting the mirror film 23c is as thin as about several millimeters or less, the change in magnification of the external image can be suppressed to be smaller. The reflectance of the mirror film 23c for the image light ML and the external light OL is set to a value from 10% to 50% in an assumed range of the incident angle of the image light ML from the viewpoint of ensuring the luminance of the image light ML and facilitating the observation of the external image in the see-through viewing. The plate-shaped body 23b which is a base material of the see-through mirror 23 is formed using, for example, a resin, but may be formed using glass. The plate-shaped body 23b is formed using the same material as a support plate 61 that supports the plate-shaped body from the periphery, and has the same thickness as the support plate 61. The mirror film 23c is, for example, formed using a dielectric multilayer film including a plurality of dielectric layers each having an adjusted film thickness. The mirror film 23c may be a single-layer film or multilayer film formed using a metal such as Al or Ag and having an adjusted film thickness. The mirror film 23c can be formed by lamination, but can also be formed by attaching a sheet-like reflection film.

Regarding the optical paths, the image light ML from the display element 11 is incident on the projection lens 21 and emitted from the projection lens 21 in a substantially collimated state. The image light ML having passed through the projection lens 21 is incident on the prism mirror 22, passes through the incident surface 22a while being refracted, is reflected by the inner reflection surface 22b at high reflectance close to 100%, and is refracted again by the emission surface 22c. The image light ML from the prism mirror 22 is incident on the see-through mirror 23 and is reflected by the reflection surface 23a at reflectance of about 50% or less. The image light ML reflected by the see-through mirror 23 is incident on the pupil position PP at which the eye EY or the pupil of the wearer US is disposed. The external light OL passing through the see-through mirror 23 and the support plate 61 around the see-through mirror is also incident on the pupil position PP. That is, the wearer US who wears the first virtual image display device 100A can observe the virtual image by the image light ML in superimposition on the external image.

Although the detailed description is omitted, in the present embodiment, an angle of a tangent line of the reflection surface 23a passing through an intersection point between the reflection surface 23a and the optical axis AX with respect to the Z axis, that is, an arrangement angle is larger in the off-axis surface or the reference surface parallel to the XY cross section of the see-through mirror 23 and the distortion in the longitudinal direction is suppressed in the first virtual image display device 100A, but a trapezoidal distortion mainly including distortion in the lateral direction occurs. However, only by suppressing the distortion in the longitudinal direction, as will be described in detail later, it is no longer necessary to hold the frame buffer in the display control device 88, and thus the distortion correction can be performed by an inexpensive integrated circuit such as a general-purpose FPGA and the power consumption can be reduced.

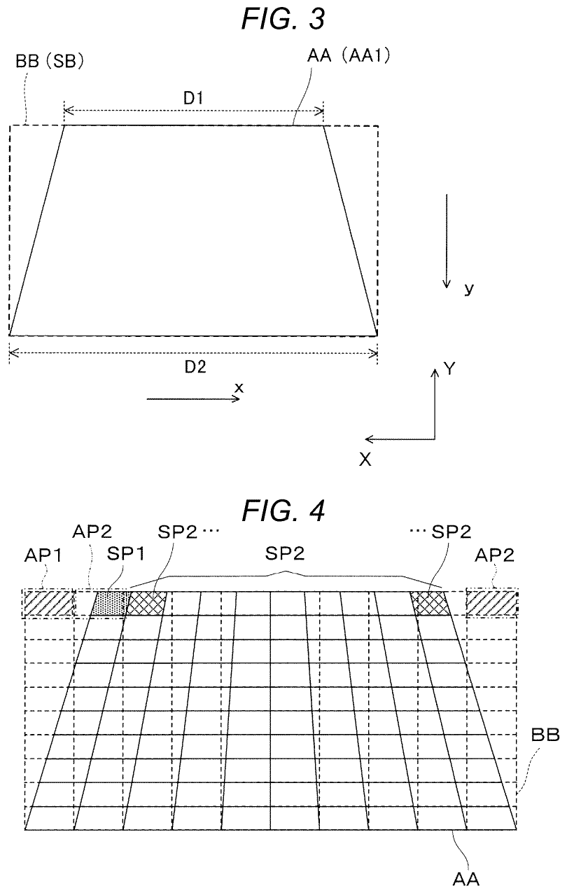

FIG. 3 is a virtual diagram illustrating a virtual image AA formed at the eye EY side and an original image BB displayed on the display element 11 when a correction is not performed by the display control device 88. In FIG. 3, a solid line indicates the virtual image AA corrected with respect to the longitudinal direction through the imaging optical system 20 of the first virtual image display device 100A, and a broken line indicates a display region SB of an ideal rectangular image corresponding to the original image BB. In the following description, an image observed by the eye EY is referred to as a virtual image or a projection image, and an image formed on the display control device 88 is referred to as an image or a display image.

In the virtual image AA formed by the first virtual image display device 100A, before a distortion correction by the display control device 88, which will be described later, a length D1 in the left-right directions corresponding to the second directions in one of the up-down directions corresponding to the first directions of a projection image AA1 corresponding to the virtual image AA is shorter than a length D2 in the left-right directions in the other of the up-down directions of the projection image AA1. For example, when the shape of the image BB before correction is a rectangle, the projection image AA1 after correction has a trapezoidal shape by an optical correction biased with respect to the directionality at projection by the imaging optical system 20 of the first virtual image display device 100A. In the example of FIG. 3, the upside or the +Y direction (corresponding to the −y direction) is the one, and the downside or the −Y direction (corresponding to the +y direction) is the other. The display control device 88 performs a distortion correction opposite to that for the trapezoidal projection image AA1, which is narrowed at the upside by signal processing, thereby shaping the virtual image after correction to be finally visually recognized in the same rectangle as the original image BB.

FIG. 4 illustrates a distortion state of the virtual image AA formed by correcting a distortion in the up-down directions in the imaging optical system 20 of the first virtual image display device 100A. As illustrated, the virtual image AA includes a first correction region SP1 after correction by optically correcting a first region AP1 of the original image BB, and a plurality of second correction regions SP2 after correction by optically correcting a plurality of second regions AP2 arranged with the first region AP1 of the image before correction in the left-right directions. The first and second regions AP1 and AP2 are introduced on the premise of a subsequent correction using signal processing, and are unit regions each having a certain spread. The first region AP1 is a reference region set for each row extending laterally. The first region AP1 and the second region AP2 correspond to one segment when the entire pixels of the image BB corresponding to the virtual image AA are longitudinally and laterally segmented into ten segments. In the original image BB, when the lateral size is 1920 pixels and the longitudinal size is 1080 pixels, one segment has 192× 108 pixels.

The first region AP1 and the second region AP2 illustrated in FIG. 4 are examples, and the ranges thereof can be appropriately set. The ranges of the first corrected region SP1 and the second corrected region SP2 are determined to correspond to the first region AP1 and the second region AP2 set in the above-described manner.

The number of pixels in the left-right directions of the first correction region SP1 after correction (the width with reference to the pixels of the original image BB) is the number of pixels whose change is within +10% with respect to the number of pixels in the left-right directions of the second correction region SP2 after correction. In the present embodiment, regarding the trapezoidal shape of the virtual image AA, the distortion distance or width of the second corrected region SP2 in the lateral direction changes substantially constantly within a range of +20 pixels with respect to the average value of the lateral lengths of the first and second corrected regions SP1 and SP2. Further, the distortion in the lateral direction changes substantially constantly within a range of +20 pixels in the longitudinal direction of the virtual image AA. That is, the distortion of the virtual image in the lateral direction gradually changes according to the longitudinal and lateral positions in units of the corrected regions SP1 and SP2, and the distortion correction using signal processing in the display control device 88 can be made easier. The distortions inherent in the imaging optical system 20 of the first virtual image display device 100A are corrected by the display control device 88 described later so as to cancel the distortions.

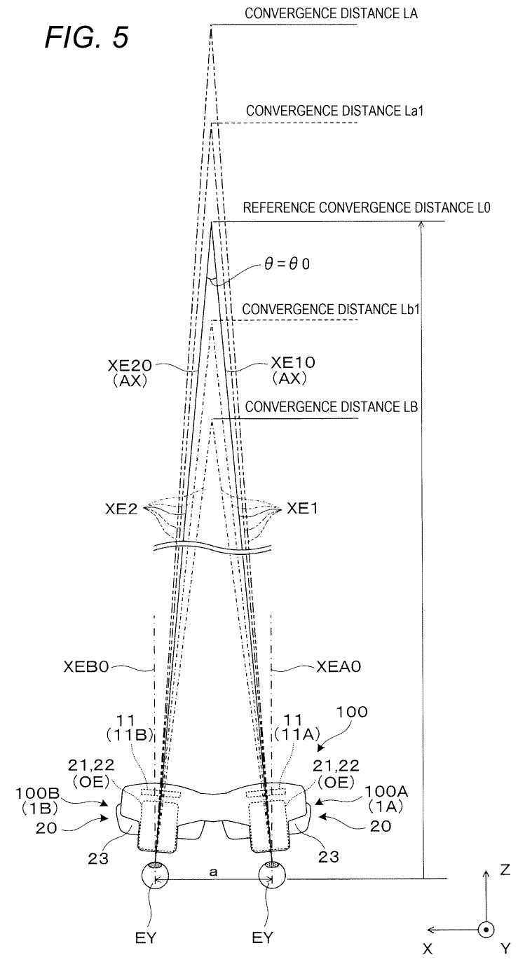

FIG. 5 illustrates settings of a convergence angle by the head-mounted display apparatus 100. In the first virtual image display device 100A for the right eye, the display element 11 and the imaging optical system 20 form a first device 1A. In the second virtual image display device 100B for the left eye, the display element 11 and the imaging optical system 20 form a second device 1B.

Referring to FIG. 5, convergence means that both eyes EY move close to each other for near vision, and an angle between visual axes XE1 and XE2 of both eyes EY is referred to as the convergence angle θ. When a standard observation distance set for the head-mounted display apparatus 100, that is, a distance at which a virtual image or a projection image is observed due to parallax is a reference convergence distance L0, a convergence angle θ=θ0 is given by θ0=2·tan⁻¹ (a/2L0) in the frontward direction. Here, the value a is a distance between both eyes EY.

In the head-mounted display apparatus 100 of the present embodiment, the positions of the virtual images or the projection images displayed by both the virtual image display devices 100A and 100B are set in directions with inward inclinations by a half of the convergence angle θ with reference to visual axes XEA0 and XEB0 in the front view. Specifically, the optical axes AX of both the virtual image display devices 100A and 100B are initially adjusted to coincide with visual axes XE10 and XE20 corresponding to the convergence angle θ=θ0 by adjusting the relative positioning of the optical systems. Accordingly, a virtual image with coincidence is observed in front at the reference convergence distance L0 by both the virtual image display devices 100A and 100B. In a specific fabrication example, the reference convergence distance L0=5 m was set.

The head-mounted display apparatus 100 of the present embodiment can adjust the observation distance of the virtual image by providing a difference in image processing in both the virtual image display devices 100A and 100B. That is, by adjusting the convergence angle θ, a virtual image can be projected at any position in a distance range between a far convergence distance LA and a near convergence distance LB across the reference convergence distance L0. For adjustment of the convergence angle θ by image processing, there is a method of shifting an image or a display image formed on the display surface 11a of the display element 11 in the +x direction or the −y direction by a conversion distance corresponding to the half value θ/2 of the convergence angle θ. However, in this method, when aberration such as a distortion in the lateral direction remains in the imaging optical system 20, a distortion at least in the lateral direction may occur in a virtual image which is a projection image as a result, and binocular vision with precision and less burden may be hindered. Although the details will be described later, in the head-mounted display apparatus 100 of the present embodiment, in the display control device 88, in order to suppress the occurrence of a distortion accompanying the adjustment of the observation distance or the convergence angle as described above, a table or a conversion formula for converting two-dimensional azimuth angles related to two directions perpendicular to the visual axes XE10 and XE20 corresponding to the basic convergence angle θ=θ0 in the space in front of the eyes and orthogonal to each other into xy coordinate positions on the display surface 11a is held. Then, at each time when the convergence distance is changed, the display control device 88 can reread the conversion table or conversion formula and project the original image corresponding to the two-dimensional distribution of azimuth angles in front of the eyes as a virtual image close to the original image.

In FIG. 5, for simplicity of the description, the Y axis is in the state perpendicular to the paper surface and the Z axis is in the state parallel to the paper surface, however, strictly, the Y axis is inclined by about 10° with respect to the state perpendicular to the paper surface and the Z axis is also inclined by about 10° with respect to the state parallel to the paper surface in relation to the emission optical axis EX (see FIG. 2).

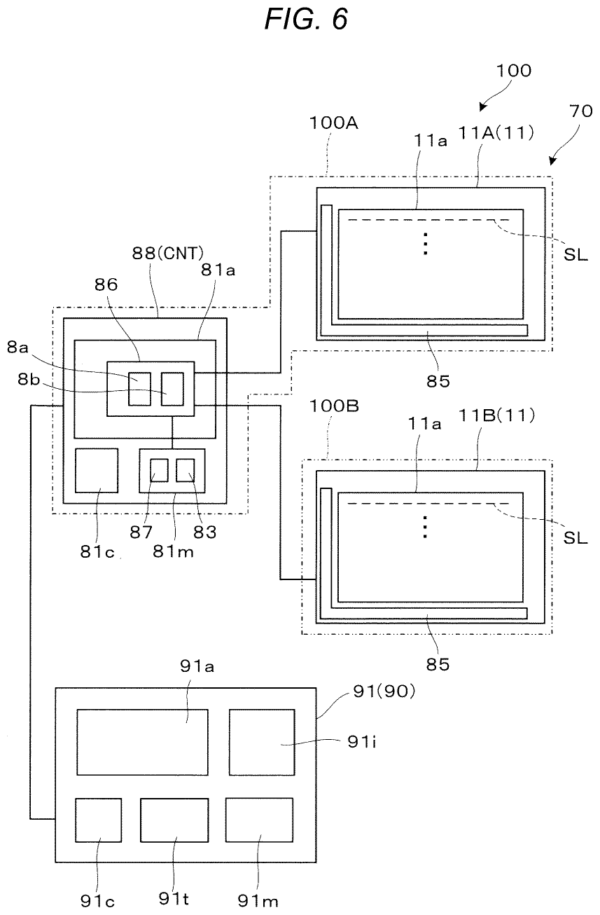

A circuit system 70 of the head-mounted display apparatus 100 will be described with reference to FIG. 6. The head-mounted display apparatus 100 includes the display control device 88, the pair of display elements 11, and a user terminal circuit 91 as the circuit system 70. One display element 11A is incorporated in the first virtual image display device 100A, and the other display element 11B is incorporated in the second virtual image display device 100B. The display control device 88 functions as a control device CNT. In the illustrated example, the display control device 88 is represented as being incorporated in the first virtual image display device 100A, but may be independent of the first virtual image display device 100A and the second virtual image display device 100B.

The display control device 88 includes an arithmetic processing device 81a, a storage device 81m, and a data communication interface 81c.

The storage device 81m stores a program for causing the first virtual image display device 100A and the second virtual image display device 100B to perform display operation. The storage device 81m stores an image acquired from the user terminal 90 as an information terminal, an image generated by the arithmetic processing device 81a, and the like. The storage device 81m includes a frame memory 83, and the frame memory 83 stores image data corresponding to image data generated by the arithmetic processing device 81a and to be output to the display element 11. The pieces of image data output from the display control device 88 to the pair of display elements 11 are slightly different from each other in order to form parallax as described later.

The storage device 81m includes a nonvolatile memory 87, and the nonvolatile memory 87 stores various data such as parameters used for calculation of image correction described later.

The display control device 88 causes the pair of display elements 11A and 11B to perform display operation. Each of the display elements 11A and 11B includes an accessory circuit 85 incorporating a scan driver and a data driver around the display surface 11a. For display of each frame image, the display control device 88 outputs a data signal corresponding to image data stored in the frame memory 83 or image data obtained by performing correction processing on the image data to the accessory circuit 85 in units of scanning lines together with a timing signal or the like, and the accessory circuit 85 rewrites the display state of the display surface 11a according to the data signal or the like input from the display control device 88. The image data is output line by line from the display control device 88 to the accessory circuit 85, and display is performed on the display surface 11a of each of the display elements 11A and 11B in the scanning direction corresponding to the x directions in FIG. 2. The x direction in FIG. 2 corresponds to the lateral directions or the left-right directions of the display surface 11a. The image data stored in the frame memory 83 increases by one line in the image of one frame, is reset after the lines of the entire image are displayed on the display element 11, and the image data of the next frame is similarly stored.

The display control device 88 can receive display data corresponding to image data from the user terminal circuit 91 via the data communication interface 81c and store the display data in the frame memory 83. The display control device 88 collectively performs processing for realizing a desired observation distance by a distortion correction for compensating for the distortion of the imaging optical system 20 remaining in the lateral direction and convergence angle adjustment between the virtual image display devices 100A and 100B on the display data or the image data stored in the frame memory 83, and outputs image data, which is the processed display data, to the display elements 11A and 11B.

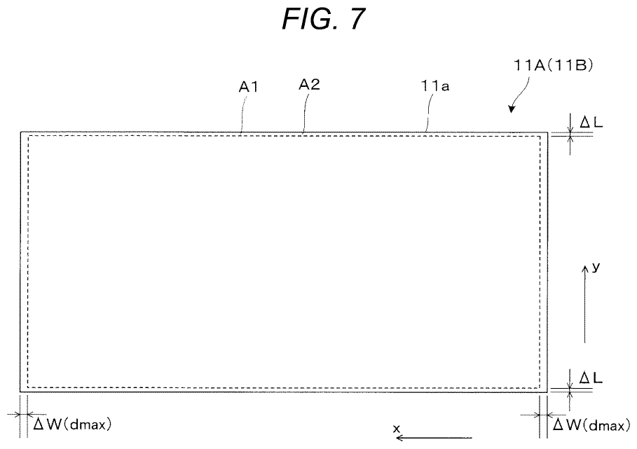

FIG. 7 illustrates the display surface 11a of the display element 11A for the right eye. The display surface 11a has a rectangular frame-shaped extended region A2 surrounding four sides of a basic region A1 outside the basic region A1 corresponding to a predetermined image size. The image size of the basic region A1 is set to a standard size, for example, 1920×1080 pixels. The extended region A2 has pixel widths of ΔW in the long side direction, that is, the x direction in the left and right short side portions, and has pixel widths of ΔL in the short side direction, that is, the y direction in the upper and lower long side portions. The pixel widths ΔW are margins necessary for convergence angle adjustment or convergence distance adjustment between the virtual image display devices 100A and 100B. The pixel widths ΔL are provided as margins for adjustment when the relative positioning of the virtual image display devices 100A and 100B is insufficient, but are unnecessary margins when the relative positioning of the virtual image display devices 100A and 100B can be performed with high accuracy. In the specific example, the pixel width ΔW is set to 16 pixels, and the pixel width ΔL is set to 12 pixels. In this case, the image size of the display surface 11a is 1952×1104 pixels. The display surface 11a of the display element 11B for the left eye has the same structure as the display surface 11a of the display element 11A for the right eye, and the description thereof will be omitted.

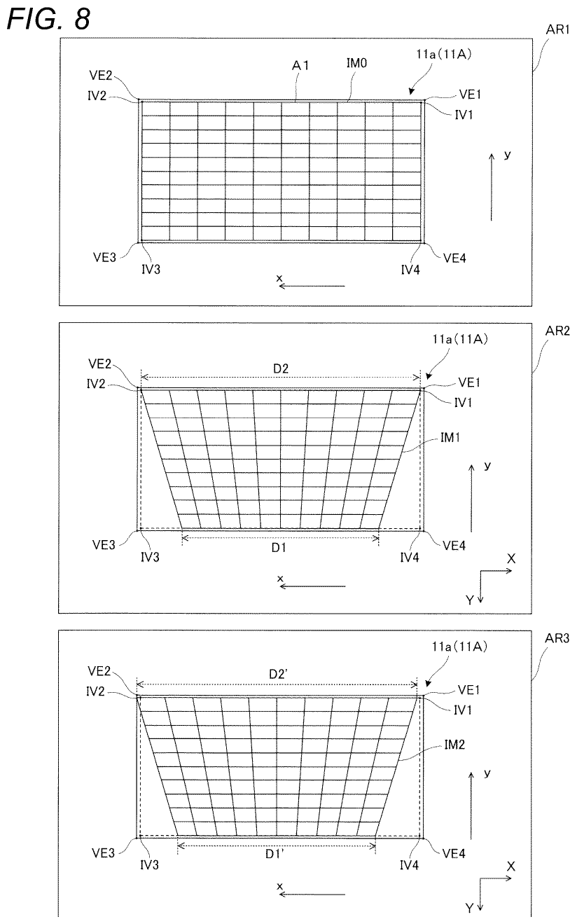

FIG. 8 illustrates a coordinate system before correction and coordinate systems after correction in the display control device 88. A diagram region AR1 in FIG. 8 is a coordinate system in a normal state before correction, and shows an initial image IM0. A diagram region AR2 in FIG. 8 is a coordinate system of a display state on the display element 11A after correction when the target of the convergence distance adjustment is the reference convergence distance L0, and illustrates a corrected image IM1. A diagram region AR3 in FIG. 8 is a coordinate system of a display state on the display element 11A after correction when the target of the convergence distance adjustment is a convergence distance La1 (see FIG. 5), and illustrates a corrected image IM2. In the specific example, the xy coordinates of vertex pixels VE1, VE2, VE3, and VE4 on the four corners in the display surface 11a of the display element 11A are (−975.5, +551.5), (+975.5, +551.5), (+975.5, −551.5) and (−975.5, −551.5). The xy coordinates of vertex pixels IV1, IV2, IV3, and IV4 on the four corners of the basic region A1 corresponding to the initial image IM0 are (−959.5, +539.5), (+959.5, +539.5), (+959.5, −539.5), and (−959.5, −539.5).

The initial image IM0 is an original display image before correction in the display control device 88. The corrected image IM1 is a display image after a distortion correction in the display control device 88. The corrected image IM1 is the display image obtained by correcting the distortion generated in the imaging optical system 20 in the lateral direction, that is, the x direction to have a rectangular shape in the virtual image formed on the eye EY side. The corrected image IM2 is a display image after the convergence distance adjustment is performed while the distortion correction is performed in the display control device 88. The corrected image IM2 is obtained by not only shifting the corrected image IM1 in the +x direction but also correcting the distortion correction amount in the lateral direction in response to the change of the convergence distance from L0 to La1. The corrected image IM2 is an image obtained by correcting a distortion generated in the imaging optical system 20 in consideration of a change in the visual axis XE1 (see FIG. 5) to have a rectangular shape in the virtual image formed on the eye EY side.

As shown in FIG. 6, the display control device 88 performs various types of image processing including arithmetic processing for distortion corrections and convergence distance adjustment so that the initial image IM0 having a rectangular contour corresponding to the input signal from the user circuit 91 becomes the corrected images IM1 and IM2 having non-rectangular contours to be displayed on the display surface 11a.

The arithmetic processing device 81a acquires an image or a display image from the user terminal 90 and stores the image or the display image in the storage device 81m. The image is a display image displayed on the head-mounted display apparatus 100, and is specifically the initial image IM0 illustrated in FIG. 8.

The arithmetic processing device 81a includes a correction unit 86 for the distortion corrections and convergence distance adjustment as illustrated in FIG. 8. The correction unit 86 is a correction circuit that not only generates a distorted image that cancels a trapezoidal screen distortion generated in the imaging optical system 20 of the first virtual image display device 100A and displays the distorted image on the display element 11, but also generates a distorted image that cancels a trapezoidal screen distortion generated in the imaging optical system 20 according to a new setting of the convergence distance and displays the distorted image on the display element 11 when the setting of the convergence distance is changed. The correction unit 86 generates a distorted image according to the convergence distance by simple calculation processing, and enables adjustment of the distortion state and the display range by parameter adjustment. The correction unit 86 is mounted on, for example, a general-purpose FPGA together with the other circuits forming the display control device 88.

In both the image shown in the diagram region AR2 of FIG. 8 and the image shown in the diagram region AR3, the image after correction displayed on the display surface 11a has a wide inverted trapezoidal shape with respect to the upside, D1<D2 and D1′<D2′, and lengths D1 and D2 and lengths D1′ and D2′ have different values and the positions of the vertices on the four corners also differ with respect to the x direction.

Returning to FIG. 6, in the arithmetic processing device 81a, the correction unit 86 includes a coordinate conversion portion 8a and a gradation conversion portion 8b.

The coordinate conversion portion 8a performs conversion of a lateral position or an x-coordinate position as correction processing as a type of image processing. Specifically, the coordinate conversion portion 8a generates the corrected image IM1 or the corrected image IM2 illustrated in FIG. 8 by performing correction processing for achieving a target convergence distance while distorting the initial image IM0 so as to compensate for lateral distortion aberration generated in the imaging optical system 20 or the like illustrated in FIG. 2.

The gradation conversion portion 8b converts the gradation or luminance of each pixel corresponding to the coordinates converted or corrected by the coordinate conversion portion 8a. That is, the gradation conversion portion 8b adjusts the gradation of the corrected images IM1 and IM2 after correction by interpolation. The gradation adjustment by the gradation conversion portion 8b is, in consideration of the fact that, when the initial image IM0 is converted into the corrected image IM1, the coordinate value in the x direction (that is, the pixel point after the coordinate conversion) deviates from the original pixel point or lattice point by an amount including an integer part and a decimal part with reference to the pixel spacing and becomes a fractional position or an intermediate position corresponding to the decimal part, to calculate gradation estimated to be appropriate with respect to the pixel point which is present around the intermediate position (specifically, in the lateral direction) on the display elements 11A and 11B for actual display from the coordinate value of the intermediate position.

Hereinafter, specific processing in the coordinate conversion portion 8a will be described. Here, it is assumed that the distortion aberration in the lateral direction generated in the imaging optical system 20 or the like illustrated in FIG. 2 is a function determined by an algebraic expression including an original position. The xy coordinate system in which the size of one pixel is 1 with the center of an image or a display image before correction as the origin is converted into the following UV coordinate system by a distortion correction or distortion conversion corresponding to compensation of distortion aberration.

When a coordinate in the up-down directions of the initial image IM0 before correction is y, a coordinate in the left-right directions of the initial image IM0 before correction is x, a coordinate in the left-right directions of the corrected image IM1 after correction is U, a coefficient corresponding to the length in the left-right directions of the corrected image IM1 after correction is a, and a coefficient corresponding to the angle formed by the side in the up-down directions and the side in the left-right directions of the corrected image IM1 after correction is b, the coordinate conversion portion 8a of the display control device 88 corrects the initial image IM0 so as to satisfy the following conversion formula.

$$U = ax + bxy \qquad ( 1 )$$

The coefficient a corresponds to a relative ratio of the original length in the left-right directions. The coefficient b corresponds to a gradient of the opposite sides of the trapezoid that are not parallel to each other, that is, a gradient of the legs or the longitude lines of the trapezoid.

When the coordinate of the corrected image IM1 after correction in the up-down directions is V, the following conversion formula is satisfied.

$$V = y \qquad ( 2 )$$

When a coefficient corresponding to a distortion between one inclination in the left-right directions in the corrected image IM1 after correction and the other inclination in the left-right directions in the corrected image IM1 after correction is c, the coordinate conversion portion 8a of the display control device 88 corrects the image so as to satisfy the following conversion formula.

$$U = ax + bxy + cy \qquad {( 1 )}^{′}$$

Note that the coefficient c corresponds to an imbalance of the inclinations of the opposite sides of the trapezoid that are not parallel to each other, that is, an imbalance of the inclinations of the legs or the longitude lines of the trapezoid. That is, when c=0, the conversion formula (1)′ matches the conversion formula (1) and means the coordinate conversion into the corrected image IM1 of an isosceles trapezoid type.

In the above description, the coefficients a, b, and c are rewritable parameters.

When it is desired to easily perform convergence distance adjustment on the corrected image IM1, the initial image IM0 before correction may be moved in the x direction according to, for example, convergence distance adjustment amounts (corresponding to convergence adjustment shift amounts L1 and L2 described later). Here, the convergence distance adjustment amount is obtained by replacing the deviation angle in the lateral direction of the virtual image for the eye EY with the positional deviation in the lateral direction, that is, the x direction on the display control device 88. Changing the convergence distance as a difference from the reference convergence distance L0 shown in FIG. 5 at the stage of the initial image IM0 by the above-described method is referred to as an image shift, and a value in units of pixels that realizes the image shift is referred to as an image shift amount LIX. The image processing using the image shift is performed by the display control device 88, and the display control device 88 can suppress the distortion related to the virtual image projected in conjunction with the image shift amount L1X of the image. However, when the above-described convergence distance adjustment is used, a virtual image corresponding to an image that deviates from the original display region, that is, the basic region A1 illustrated in FIG. 7 and protrudes laterally is not displayed in principle, and missing occurs in the image. Further, the virtual image obtained by projecting the image in the basic region A1 also has a slight distortion because the distortion aberration is not sufficiently corrected due to the movement of the eyeball or the like.

When it is desired to obtain the corrected image IM2 in which the convergence distance adjustment is precisely performed, it is conceivable to correct the coefficients a, b, and c for coordinate conversion in a stepwise manner according to the convergence distance adjustment amounts (corresponding to convergence adjustment shift amounts L1 and L2 to be described later) with respect to the original image IM0 before correction. Changing the convergence distance as a difference from the reference convergence distance L0 illustrated in FIG. 5 at the stage of the coordinate conversion by the above-described method is referred to as a conversion shift, and a value in units of pixels that realizes the conversion shift is referred to as a conversion shift amount d1x. The conversion shift is performed with reference to the visual axis XE1. Accurate coefficients a, b, and c are determined in advance through a simulation or actual measurement, and thus a virtual image with little distortion can be projected by utilizing the entire display surface 11a shown in FIG. 7. The above-described image processing is performed by the display control device 88, and the display control device 88 changes the correction amount for canceling the distortion related to the virtual image projected in conjunction with the conversion shift amount d1x of the image.

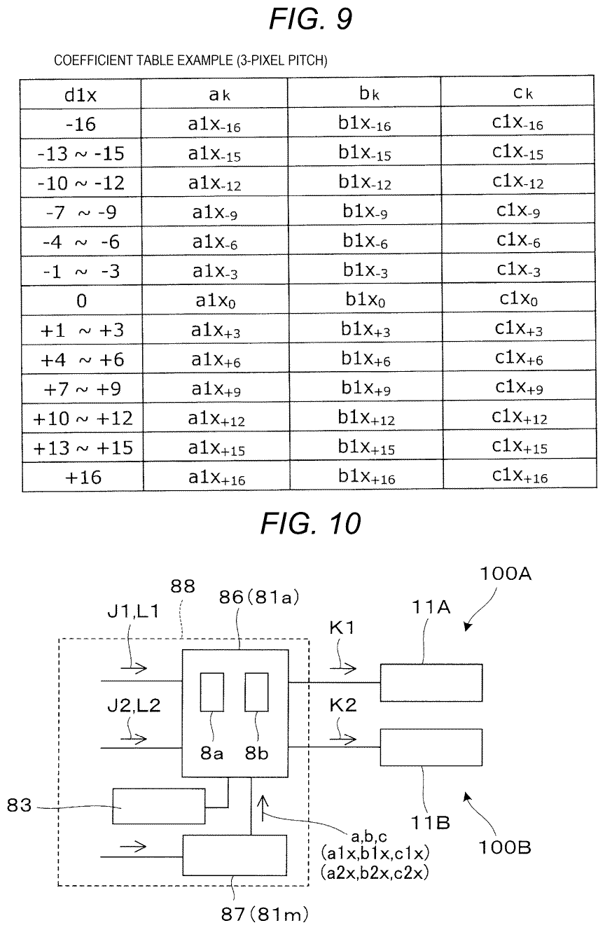

FIG. 9 illustrates a coefficient table in which variable coefficients a, b, and c are set for conversion shift amounts dx. Here, (ak, bk, ck)=(a1x, b1x, c1x) means a coefficient set (a, b, c) when the conversion shift amount d1x is-16 to +16, where k is an integer. However, for example, when the integer k is +1 to +3, the coefficient set (a1x_{+3,} b1x₊₃, c1x₊₃) is common. That is, the coefficient set (a1x, b1x, c1x) is prepared in units of three pixels, that is, in units of a plurality of pixels with respect to a change in the conversion shift amount d1x, and is kept constant within a variation range of three pixels. This is because the distortion amount in the imaging optical system 20 illustrated in FIG. 2 hardly changes when the shift amount is about +1 pixel. Note that the coefficient set (a1x, b1x, c1x) may be prepared in units of one pixel for a change in the conversion shift amount d1x, or may be prepared in units of two pixels or four or more pixels for a change in the conversion shift amount d1x. The conversion shift amount dx has an upper limit of +16, the maximum shift amount dxmax=16, and a lower limit of −16, the minimum shift amount −dxmax=−16, but can be increased or decreased according to the setting of the setting range of the convergence distance. However, it is necessary to match the pixel width ΔW of the extended region A2 provided on the display surface 11a with the maximum shift amount dxmax according to the setting of the maximum shift amount (upper limit value) dxmax or the like.

The convergence distance adjustment related to driving of the display element 11A of the one first virtual image display device 100A has been described above, and convergence distance adjustment related to driving of the display element 11B of the other second virtual image display device 100B is the same. However, in the case of the display element 11B, when the conversion shift is performed, a conversion shift amount d2x is adjusted to −16 to +16, and a coefficient set (a, b, c) corresponding thereto is a coefficient set (ak, bk, ck)=(a2x, b2x, c2x). Since the direction of the conversion shift is reversed between the first virtual image display device 100A and the second virtual image display device 100B, d2x=−d1x holds. In the case of the display element 11B, when the image shift is performed, an image shift amount is L2X, and L2X=−L1X.

FIG. 10 is a block diagram partially illustrating the display control device 88 and the display elements 11A and 11B. The coordinate conversion portion 8a of the correction unit 86 in the drawing receives the image signal of the first virtual image display device 100A for the right eye and the image signal of the second virtual image display device 100B for the left eye, and performs distortion conversion processing on each image signal.

As illustrated in FIG. 10, a coefficient set (a, b, c)=(ak, bk, ck) that provides a conversion formula for coordinate conversion, that is, coefficient sets (a1x, b1x, c1x) and (a2x, b2x, c2x) are recorded in the nonvolatile memory 87 that can be rewritten from the outside in the storage device 81m, and the correction unit 86 acquires coefficient values recorded in the nonvolatile memory 87 and performs distortion calculation. Specifically, the coordinate conversion portion 8a of the correction unit 86 receives an input signal J1 corresponding to the image signal for the first virtual image display device 100A and the convergence adjustment shift amount L1, and receives an input signal J2 corresponding to the image signal for the second virtual image display device 100B and the convergence adjustment shift amount L2. Here, the convergence adjustment shift amount L1 corresponds to a convergence distance adjustment amount in the horizontal direction for the right eye EY, and the convergence adjustment shift amount L2 corresponds to a convergence distance adjustment amount in the horizontal direction for the left eye EY. The coordinate conversion portion 8a performs calculation processing on the input signal J1 using the coefficient set (a1x, b1x, c1x) corresponding to the convergence adjustment shift amount L1, and outputs an output signal K1 to the display element 11A. The coordinate conversion portion 8a performs calculation processing on the input signal J2 using the coefficient set (a2x, b2x, c2x), and outputs an output signal K2 to the display element 11B. Here, the coefficient sets (a1x, b1x, c1x) and (a2x, b2x, c2x) are selected from the coefficient table illustrated in FIG. 9 according to the conversion shift amounts d1x and d2x determined from the convergence adjustment shift amounts L1 and L2 according to a rule described later. The correction unit 86 may output two output signals in different distortion states with one input system instead of two input systems.

The values of the right-eye coefficient set (a1x, b1x, c1x) and the left-eye coefficient set (a2x, b2x, c2x) are stored in the nonvolatile memory 87, and the coefficients a1x, b1x, c1x, a2x, b2x, and c2x are acquired for distortion processing of the correction unit 86 and calculation processing involving coordinate conversion or conversion is performed. Accordingly, the images for the right eye and the left eye can be output to the display elements 11A and 11B in different distortion states. The coefficients for coordinate conversion recorded in the nonvolatile memory 87 can be accessed and rewritten from the outside by a serial communication method such as I2C. The correction unit 86 also performs interface conversion for conversion into image signals suitable for the display elements 11A and 11B. The correction unit 86 used in practice includes, for example, an FPGA, and LIFCL-17-8MG121C manufactured by Lattice Corporation may be used as a specific example.

The corrections as illustrated in FIG. 8 achieved by the coordinate conversion portion 8a can not only correct the distortion of the imaging optical system 20 as illustrated in FIG. 4 but also set the convergence distances of the virtual image display devices 100A and 100B to target values. In the present embodiment, the display element 11 is inversely disposed in which the upside is disposed downward with respect to the coordinates of the imaging optical system 20, that is, in the −Y direction. The image through the imaging optical system 20 is vertically and horizontally inverted by a relay system, and the virtual image visually recognized by the wearer US is subjected to trapezoidal correction and the directionality of the display content matches that of the original image.

When the coordinate conversion portion 8a converts a color image, it is desirable to suppress the occurrence of chromatic aberration, and an image containing several wavelengths is converted so as to be displayed on the display element 11 in the following manner.

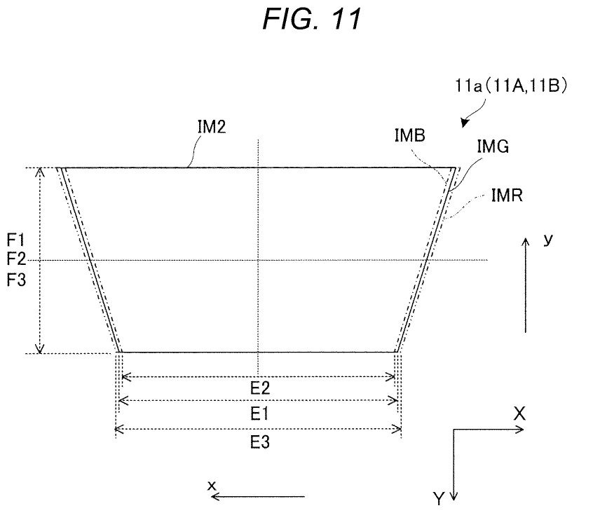

Specifically, as illustrated in FIG. 11, the display elements 11A and 11B display, as the corrected image IM2, a first image IMG containing a first wavelength, a second image IMB containing a second wavelength shorter than the first wavelength, and a third image IMR containing a third wavelength longer than the first wavelength. In this case, a length E1 of the first image IMG in the left-right directions is a length between a length E2 of the second image IMB in the left-right directions and a length E3 of the third image IMR in the left-right directions, and a length F1 of the first image IMG in the up-down directions is the same as a length F2 of the second image IMB in the up-down directions and a length F3 of the third image IMR in the up-down directions. Accordingly, the correction amount can be changed for each wavelength band, and the display accuracy of the color image can be improved.

Referring back to FIG. 6, gradation adjustment processing in the gradation conversion portion 8b will be described below. The gradation conversion portion 8b performs, for example, linear interpolation.

After the coordinate conversion portion 8a derives the coordinate values after correction, the gradation conversion portion 8b performs interpolation processing to appropriately derive gradation values of the pixels of the display elements 11A and 11B. In this case, the simplest method is nearest neighbor interpolation. This is a method of using the gradation value of the closest coordinate value as it is, but for example, a straight line and a character are likely to be jagged or crushed. In contrast, when cubic spline interpolation with the gradation values of the four neighboring points is used, a smoother image can be displayed, but the calculation processing becomes complicated. In the present embodiment, N-segment linear interpolation that is feasible by simple calculation processing for deriving a gradation value is performed based on linear interpolation.

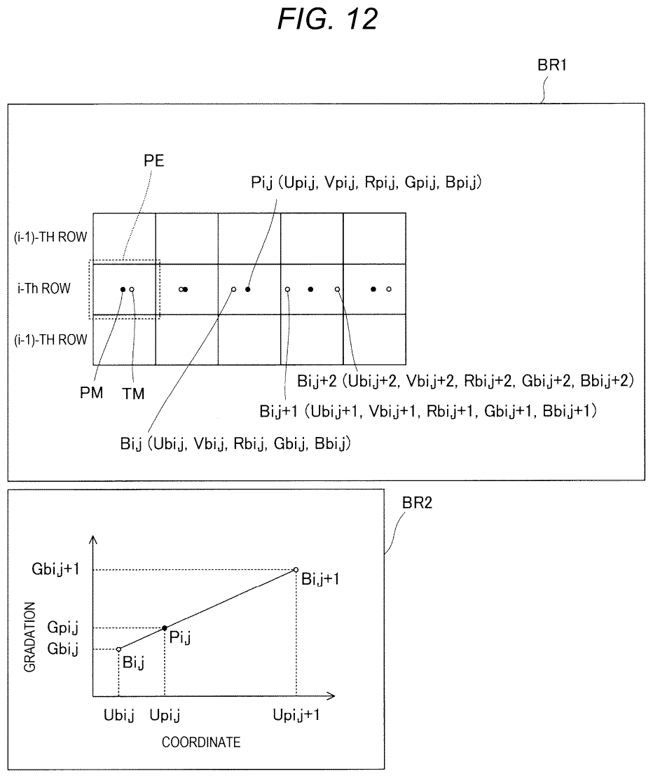

A calculation method used for linear interpolation corresponding to gradation adjustment will be described below with reference to FIG. 12. A diagram region BR1 of FIG. 12 illustrates a relationship between pixel center coordinates PM and converted coordinates TM in a pixel PE of an i-th row of the display element 11. In FIG. 12, a value Up_{i,j} indicates an x-coordinate, a value Vp_{i,j} indicates a y-coordinate, a value Rp_{i,j} indicates a gradation value of red, a value Gp_{i,j} indicates a gradation value of green, and a value Bp_{i,j} indicates a gradation value of blue. The interpolation calculation is performed for each line and each wavelength.

A diagram region BR2 in FIG. 12 illustrates, for example, the pixel center coordinates PM in a green image and the gradation value corresponding to the converted coordinates TM. As illustrated in the diagram region BR2 of FIG. 12, with respect to gradation values Gb_{i,j}, Gb_{i,j+1} and coordinates B_{i,j} (Ub_{i,j}, Vb_{i,j}), B_{i,j+1} (Ub_{i,j+1}, Vb_{i,j+1}) of two points B_{i,j}, B_{i,j+1} after correction or conversion, when a gradation value Gp_{i,j} and coordinates (Up_{i,j}, Vp_{i,j}) are set for a pixel P_{i,j} of the display element 11A present between the two points, a gradation value Gp_{i,j} of green of a pixel P_{i,j} of the display element 11A or 11B is calculated by the following expression.

$${Gp}_{i , j} = {Gb}_{i , j} + α ( {Gb}_{i , j + 1} - {Gb}_{i , j} )$$

Here, the value α is a coefficient corresponding to the inclination of the line segment indicating the relationship between the coordinates and the gradation, which enables interpolation of the gradation, and is 1 or less.

Although the detailed description is omitted, the gradation values of the red and blue pixels are calculated by the same method as described above.

The gradation adjustment by the linear interpolation has been described above, and the gradation adjustment can be performed using various approximation methods other than the linear interpolation.

The user terminal circuit 91 shown in FIG. 6 is incorporated in the user terminal 90, and includes a main control device 91a, a storage device 91m, a data communication interface 91c, a mobile wireless communication device 91t, and a user interface device 91i. The user terminal circuit 91 can communicate with various devices such as an external server via a communication network (not illustrated) by the mobile wireless communication device 91t. The storage device 91m stores a basic program for operating the user terminal circuit 91, and stores a plurality of pieces of application software including, for example, a viewer for moving image reproduction, a web browser, and the like as application software operating on the basic program. The user terminal circuit 91 operates in response to a request from the user interface device 91i operated by the user and outputs a moving image or a still image stored in the storage device 91m in association with application software to the display control device 88 in a predetermined format, or acquires moving images or still images corresponding to various contents via the mobile wireless communication device 91t and outputs the acquired display data to the display control device 88 in a predetermined format. In the above description, the display control device 88 performs the distortion correction processing and the convergence distance adjustment on the display data input from the user terminal circuit 91, but the user terminal circuit 91 may perform the distortion correction processing and the convergence distance adjustment on the display data.

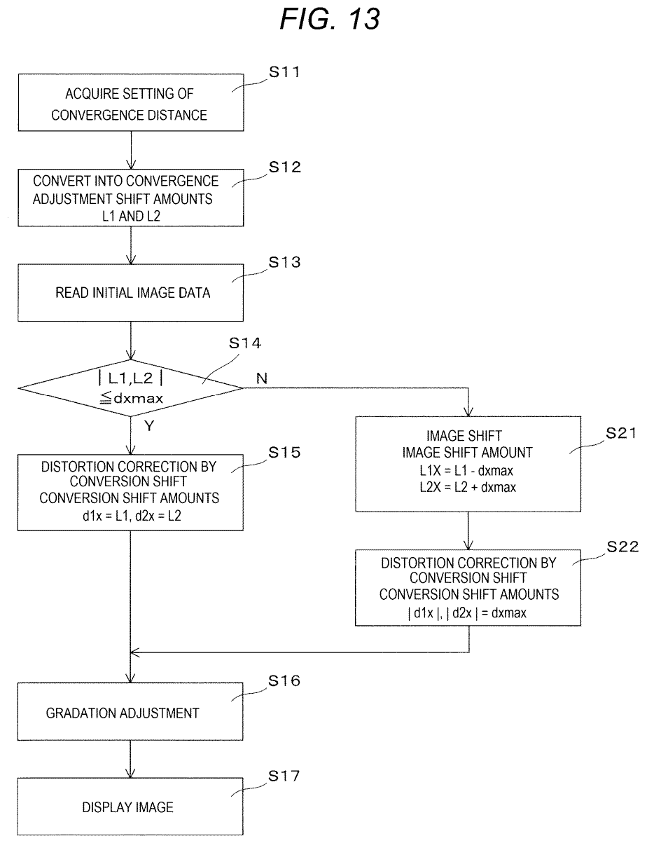

Hereinafter, image processing for display on the display surfaces 11a of the display elements 11A and 11B will be described with reference to FIG. 13.

First, in the display control device 88 illustrated in FIG. 6, the arithmetic processing device 81a acquires the setting of the convergence distance (the convergence adjustment shift amounts L1 and L2 in FIG. 10) from the user terminal 90 via the data communication interface 81c (step S11). The convergence distance is set in a range of convergence distances LA to LB illustrated in FIG. 5. The setting of the convergence distance is made by the user, for example, but may be captured as data associated with the initial image IM0 described later. The arithmetic processing device 81a converts the setting of the convergence distance into the convergence adjustment shift amounts L1 and L2 in units of pixels (step S12). The convergence adjustment shift amounts L1 and L2 are, for example, +50 pixels at maximum.

Then, the arithmetic processing device 81a acquires the initial image IM0 as display data (the input signals J1 and J2 in FIG. 10) from the user terminal 90 via the data communication interface 81c, that is, reads the initial image IM0 as image data, and stores the initial image in the storage device 81m (step S13). The user terminal circuit 91 outputs a moving image or a still image stored in the storage device 91m to the display control device 88 in a predetermined format, or outputs a moving image or a still image acquired via the mobile wireless communication device 91t to the display control device 88 in a predetermined format.

Then, in the display control device 88, the arithmetic processing device 81a determines whether the absolute values of the convergence adjustment shift amounts L1 and L2 are equal to or less than the maximum shift amount (upper limit value) dxmax (step S14), and performs different processing depending on the result. Here, the maximum shift amount dxmax corresponds to the convergence distances La1 and Lb1 shown in FIG. 5.

When the absolute values of the convergence adjustment shift amounts L1 and L2 are equal to or less than the maximum shift amount dxmax as the upper limit value, the arithmetic processing device 81a performs distortion correction only by the conversion shift without the image shift (step S15). Here, processing of changing the correction amount for canceling the distortion according to a target conversion shift amount, specifically, selection or change of the coefficient is performed based on the coefficient table shown in FIG. 9. The conversion shift amount d1x related to the display element 11A becomes equal to the convergence adjustment shift amount L1, and the conversion shift amount d2x related to the display element 11B becomes equal to the convergence adjustment shift amount L2. As a result, the distortion correction and the convergence distance adjustment are collectively performed.

Then, the arithmetic processing device 81a as the gradation conversion portion 8b of the correction unit 86 performs gradation adjustment for each pixel in the corrected image IM2 on the premise that the initial image IM0 is coordinate-converted into the corrected image IM2 (step S16). That is, the arithmetic processing device 81a performs gradation adjustment at each pixel point forming the display elements 11A and 11B by interpolation from the pixel point of the corrected image IM2 after the coordinate conversion.

The arithmetic processing device 81a outputs the image data obtained by performing the gradation adjustment on the corrected image IM2 subjected to the distortion correction and the convergence distance adjustment to the display elements 11A and 11B, or reads the image data of the corrected image IM2 or the like from the frame memory 83 of the storage device 81m for each line, transfers the image data to the display elements 11A and 11B, and displays an image on the display surface 11a (step S17). The trapezoidal corrected image IM2 or the like displayed on the display element 11 and subjected to gradation adjustment is visually recognized as a rectangular image in the virtual image projected through the imaging optical system 20.

When the absolute values of the convergence adjustment shift amounts L1 and L2 exceed the maximum shift amount dxmax as t the upper limit value, the arithmetic processing device 81a first performs distortion correction by image shift as the correction of the first stage (step S21). In this case, the image shift amount LIX related to the display element 11A is, for example, a positive value and is L1−dxmax, and the image shift amount L2X related to the display element 11B is, for example, a negative value and is L2+dxmax due to left-right symmetry. The image shift amounts L1−dxmax and L2+dxmax are parts of convergence distance adjustment amounts (corresponding to the convergence adjustment shift amounts L1 and L2 described later). When the image shift amount LIX is a negative value and the image shift amount L2X is a positive value, the image shift amounts are L1−(−dxmax)=L1+dxmax and L2+ (−dxmax)=L2−dxmax.

Then, the arithmetic processing device 81a performs distortion correction by conversion shift as a correction at the second stage (step S22). Here, processing of changing the correction amount for canceling the distortion according to a target conversion shift amount is performed. The absolute value of the conversion shift amount d1x related to the display element 11A becomes equal to the maximum shift amount dxmax, and the absolute value of the conversion shift amount d2x related to the display element 11B also becomes equal to the maximum shift amount dxmax. Strictly, when the convergence adjustment shift amount L1 is positive, the conversion shift amount d1x is also positive, but in this case, the convergence adjustment shift amount L2 is negative due to left-right symmetry, and thus the conversion shift amount d2x is negative.

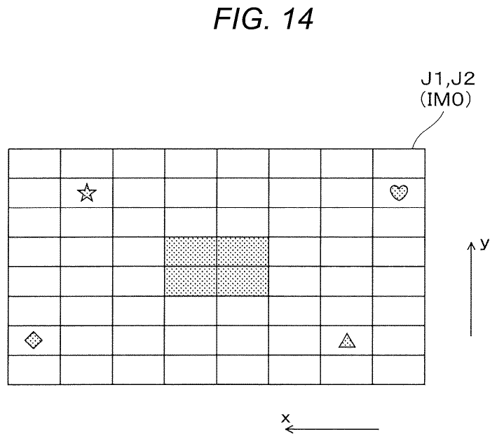

The adjustment of the convergence distance and the like will be described in detail with reference to FIGS. 14 to 16.

FIG. 14 illustrates the original initial image IM0 captured from the user terminal 90 or the like in step S13.

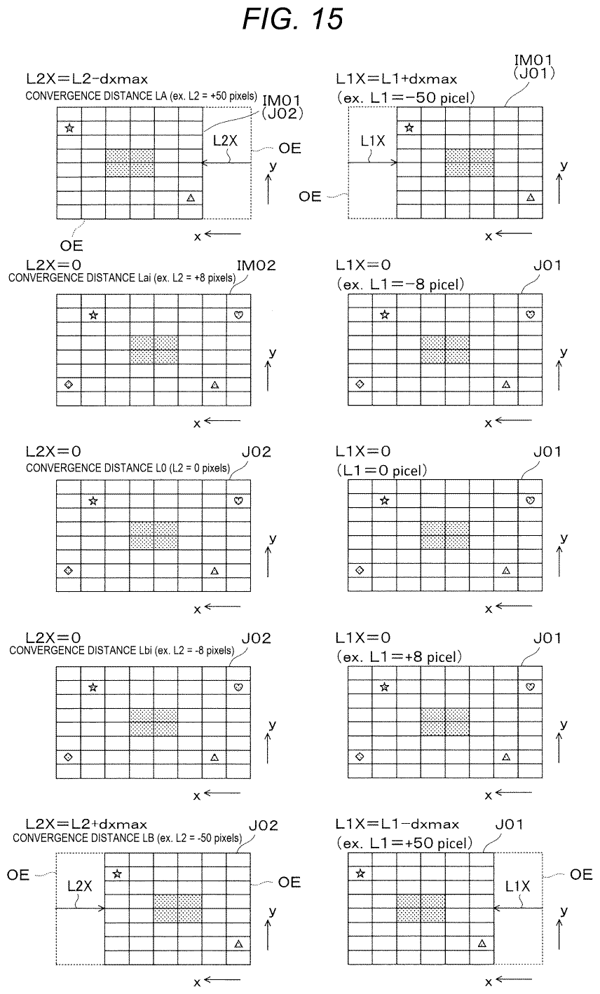

FIG. 15 illustrates the images IM01 before the distortion correction is performed by conversion shift in steps S15 and S22. The right column shows an image J01 being processed for the display element 11A for the right eye, and corresponds to the input signal J1 in FIG. 10. The left column shows an image J02 being processed for the display element 11B for the left eye, and corresponds to the input signal J2 in FIG. 10. The convergence adjustment shift amounts L1 and L2 added to the respective images IM01 correspond to the convergence distance LA, the convergence distance Lai (L0<Lai≤La1), the reference convergence distance L0, the convergence distance Lbi (Lb1≤Lbi <L0), and the convergence distance LB in FIG. 5 sequentially from the top, and the image shift amount LIX is L1+dxmax, 0, 0, 0, L1−dxmax. Further, the image shift amount L2X is L2−dxmax, 0, 0, 0, L2+dxmax. The image shift amounts L1X and L2X of 0 mean that the image shift is not performed.

In the specific example, when the convergence adjustment shift amount L1 is −50 pixels, an image shift of L1X=L1−(−dxmax)=−34 pixels is performed, and conversely, when the convergence adjustment shift amount L1 is +50 pixels, an image shift of L1−dxmax=34 pixels is performed. When the convergence adjustment shift amount L2 is +50 pixels, an image shift of L2X=L2−dxmax=+34 pixels is performed, and conversely, when the convergence adjustment shift amount L2 is −50 pixels, an image shift of L2+dxmax=−34 pixels is performed. When the convergence adjustment shift amount L1 is +8 pixels, the image shift is not performed.

At the image shift, the image is cut in one end portion, but from the viewpoint of ensuring symmetry, the image is cut in both left and right end portions. Specifically, the image at the left of the column of the star mark and the image at the right of the column of the triangle mark are cut, and as a result, the angle of view is narrowed.

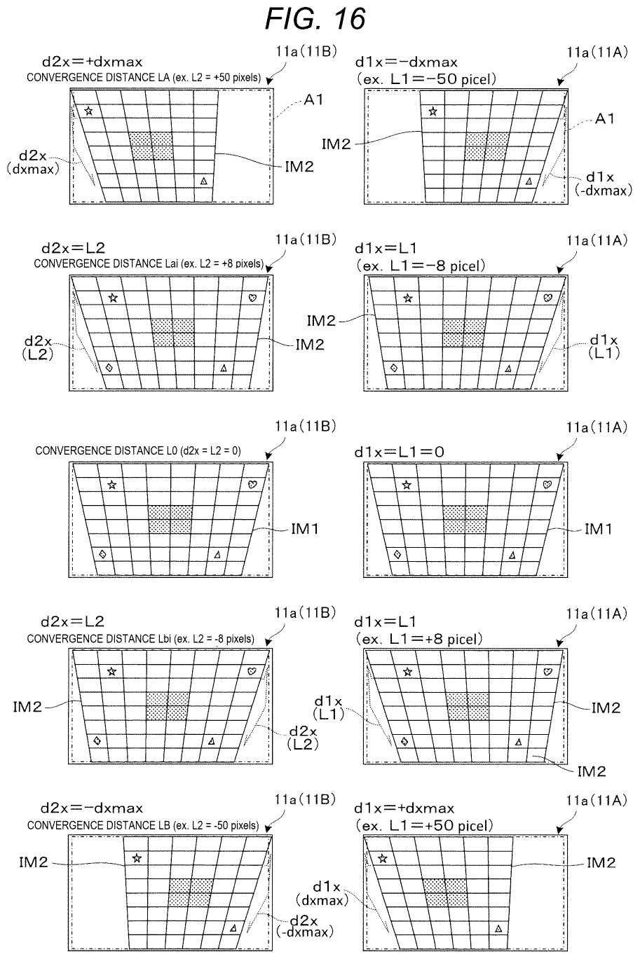

FIG. 16 illustrates the corrected image IM2 and the like after the distortion correction by conversion shift is performed. The right column indicates the display surface 11a of the display element 11A for the right eye, and corresponds to the output signal K1 to the display element 11A. The left column indicates the display surface 11a of the display element 11B for the left eye, and corresponds to the output signal K2 to the display element 11B. The conversion shift amounts d1x and d2x added to the corrected images IM2 and the like correspond to the convergence distances LA, Lai, L0, Lbi, and LB sequentially from the top, and the conversion shift amount d1x is −dxmax, L1, 0, L1, +dxmax. Further, the conversion shift amount d2x is +dxmax, L2, 0, L2, −dxmax.

In the specific example, when the convergence adjustment shift amount L1 is, for example, +50 pixels, a conversion shift of the dxmax pixels is performed, and the coordinate conversion coefficient set (a1x, b1x, c1x) therefor is (a1x₊₁₆, b1x₊₁₆, c1x₊₁₆) with reference to FIG. 9, and when the convergence adjustment shift amount L2 is, for example, −50 pixels, a conversion shift of the −dxmax pixels is performed, and the coordinate conversion coefficient set (a2x, b2x, c2x) therefor corresponds to (a1x₋₁₆, b1x₋₁₆, c1x₋₁₆) in FIG. 9 on the premise that there is left-right symmetry in the present embodiment. When the convergence adjustment shift amount L1 is −50 pixels, a conversion shift of −dxmax pixels is performed, and when the convergence adjustment shift amount L2 is +50 pixels, a conversion shift of +dxmax pixels is performed. When the convergence adjustment shift amount L1 is +8 pixels, a conversion shift of +8 pixels is performed, and the coordinate conversion coefficient set (a1x, b1x, c1x) therefor is (a1x₊₉, b1x₊₉, c1x₊₉) with reference to FIG. 9, and when the convergence adjustment shift amount L2 is −8 pixels, a conversion shift of −8 pixels is performed, and the coordinate conversion coefficient set (a2x, b2x, c2x) therefor corresponds to (a1x₋₉, b1x₋₉, c1x₋₉) in FIG. 9 on the premise that there is left-right symmetry in the present embodiment. Further, when the convergence adjustment shift amount L1 is −8 pixels, a conversion shift of −8 pixels is approximately performed as described above, and when the convergence adjustment shift amount L2 is +8 pixels, a conversion shift of +8 pixels is approximately performed as described above.

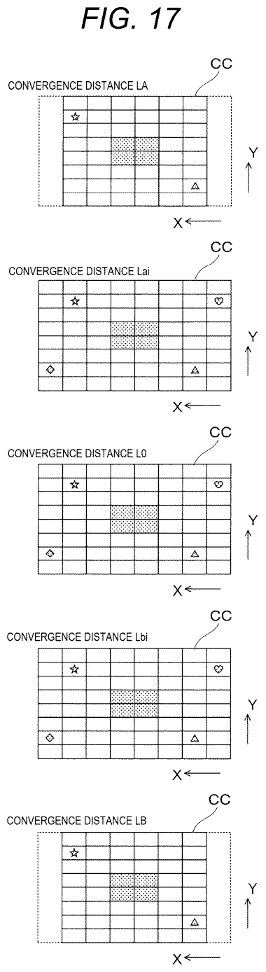

FIG. 17 illustrates virtual images CC observed by both eyes EY at convergence distances LA, Lai, L0, Lbi, and LB. As described with reference to FIG. 15, the left and right ends of the virtual image CC subjected to the image shift are cut.

The head-mounted display apparatus 100 according to the embodiment described above includes the display elements 11A and 11B that display an image, the optical member OE on which the image light ML corresponding to the image is incident, the reflection member RE that reflects the image light ML from the optical member OE and projects a virtual image corresponding to the image, and the display control device 88 as a control device that corrects the image displayed by the display elements 11A and 11B so as to cancel the distortion of the virtual image projected by the optical member OE and the reflection member RE, wherein the display control device 88 changes the correction amount of the distortion related to the virtual image in conjunction with the conversion shift amount d1x of the image as at least a part of the convergence distance adjustment amount, when the convergence distance of the virtual image is adjusted by the convergence distance adjustment amount with respect to the horizontal direction, that is, the convergence adjustment shift amounts L1 and L2.

In the head-mounted display apparatus 100, when adjusting the convergence distance of the virtual image by the convergence distance adjustment amount with respect to the horizontal direction, the display control device 88 changes the correction amount of the distortion related to the virtual image in conjunction with the conversion shift amount d1x of the image as at least a part of the convergence distance adjustment amount, and thus generation of the distortion in the projected virtual image can be suppressed.

### MODIFICATIONS AND OTHERS

The present disclosure has been described above with reference to the embodiment, but is not limited to the embodiment described above, and can be implemented in various forms without departing from the gist of the present disclosure. For example, variations below are conceivable.

In the virtual image display devices 100A and 100B, in the imaging optical system 20, a distortion in the longitudinal direction is suppressed and a trapezoidal distortion mainly including the distortion in the lateral direction is generated, but, for example, a distortion may be generated in the longitudinal and lateral directions like a barrel shape, and further, an asymmetric distortion may be generated in the up-down and left-right directions. In this case, the display control device 88 is required to correct distortion or distortion in the longitudinal and lateral xy directions, and required to change the correction amount of the distortion correction related to the virtual image in conjunction with the conversion shift amount. Here, when the initial image IM0 is converted into the corrected image IM1, the coordinate values in the xy directions are at the intermediate position of the pixel point or the lattice point, and thus it is desirable to calculate accurate gradation for the pixel points present around the intermediate position in the longitudinal and lateral directions on the display elements 11A and 11B from the coordinate values of the intermediate position.

In the virtual image display devices 100A and 100B, the component elements of the imaging optical system 20 are merely examples. In the imaging optical system 20, the projection lens 21 is configured using the three lenses, but may be configured using one, two, or four or more lenses. In the imaging optical system 20, the projection lens 21 may not necessarily be provided.

A dimming device for dimming by limiting the transmitted light of the see-through mirror 23 can be attached to the outside of the see-through mirror 23. The dimming device adjusts the transmittance electrically, for example. As the dimming device, a mirror liquid crystal, an electronic shade, or the like can be used. The dimming device may adjust the transmittance according to the external light illuminance.

The head-mounted display apparatus 100 may include only one of the virtual image display devices 100A and 100B. In this case, the operation including the adjustment of the display position can be performed without deteriorating the display state of the virtual image according to the point of view.

A virtual image display device according to a specific aspect includes a display element that displays an image, an optical member on which an image light corresponding to the image is incident, a reflection member that reflects the image light from the optical member to project a virtual image corresponding to the image, and a control device that corrects the image to be displayed by the display element so as to cancel a distortion of the virtual image projected by the optical member and the reflection member, wherein, when adjusting a convergence distance of the virtual image by a convergence distance adjustment amount with respect to a horizontal direction, the control device changes a correction amount of the distortion related to the virtual image in conjunction with a conversion shift amount of the image as at least a part of the convergence distance adjustment amount.

In the virtual image display device, when adjusting the convergence distance of the virtual image by the convergence distance adjustment amount with respect to the horizontal direction, the control device changes the correction amount of the distortion related to the virtual image in conjunction with the conversion shift amount of the image as at least a part of the convergence distance adjustment amount, and thus generation of a distortion in the projected virtual image can be suppressed.

In the specific aspect, when the convergence distance adjustment amount exceeds a predetermined upper limit value, the control device performs a first-stage correction of applying an image shift corresponding to a difference from the upper limit value to the display element, and performs a second-stage correction of canceling the distortion related to the virtual image in conjunction with a conversion shift amount of the image corresponding to the upper limit value. When the convergence distance adjustment amount is larger, a deficiency of the convergence adjustment shift amount by conversion shift can be filled up by image shift.

In the specific aspect, when the convergence distance adjustment amount does not exceed the predetermined upper limit value, the control device performs a correction of canceling the distortion related to the virtual image in conjunction with the conversion shift amount. When the convergence distance adjustment amount is not large, the convergence distance can be adjusted only by conversion shift.

In the specific aspect, the display element has an extended region for a correction of canceling the distortion related to the virtual image in conjunction with the conversion shift amount within a range in which the convergence distance adjustment amount does not exceed the predetermined upper limit value. In this case, even when the convergence distance is adjusted by conversion shift, missing in the image can be prevented.

In the specific aspect, the control device performs a correction of canceling the distortion related to the virtual image by coordinate conversion using a conversion formula an including original coordinate position and a coefficient, and changes the coefficient of the conversion formula according to a change in the conversion shift amount.

In the specific aspect, the conversion shift amount is changed in units of one pixel or in units of a plurality of pixels.

In the specific aspect, the control device performs gradation adjustment at a pixel point of the display element by interpolation from the pixel point after the coordinate conversion. In this case, deterioration of an image can be suppressed when the convergence distance is adjusted.

In the specific aspect, the control device corrects a distortion in a first direction corresponding to a horizontal direction, and corrects a distortion in a second direction different from the first direction of the virtual image by the optical member and the reflection member. As a result, it is not necessary for the control unit to perform distortion correction processing according to the distortion in the second direction related to the virtual image, and only necessary to correct the distortion in one direction, so that the load on the control unit by the distortion correction of the image can be reduced.

A head-mounted display apparatus according to a specific aspect includes a first device including the virtual image display device described above and a second device including the virtual image display device described above, and a convergence distance adjustment amount of the first device and a convergence distance adjustment amount of the second device are the same in magnitude and opposite in direction.

What is claimed is:

1. A virtual image display device, comprising:
a display element that is configured to display an image;
an optical member on which an image light corresponding to the image is incident;
a reflection member that is configured to reflect the image light from the optical member to project a virtual image corresponding to the image; and
a control device that is configured to correct the image to be displayed by the display element so as to cancel a distortion of the virtual image projected by the optical member and the reflection member, wherein
when adjusting a convergence distance of the virtual image by a convergence distance adjustment amount with respect to a horizontal direction, the control device is configured to change a correction amount of the distortion related to the virtual image in conjunction with conversion shift amount of the image as at least a part of the convergence distance adjustment amount.

2. The virtual image display device according to claim 1, wherein
when the convergence distance adjustment amount exceeds a predetermined upper limit value, the control device is configured to perform a first-stage correction of applying an image shift corresponding to a difference from the upper limit value to the display element, and perform a second-stage correction of canceling the distortion related to the virtual image in conjunction with a conversion shift amount of the image corresponding to the upper limit value.

3. The virtual image display device according to claim 2, wherein
when the convergence distance adjustment amount does not exceed the predetermined upper limit value, the control device is configured to perform a correction of canceling the distortion related to the virtual image in conjunction with the conversion shift amount.

4. The virtual image display device according to claim 2, wherein
the display element has an extended region for a correction of canceling the distortion related to the virtual image in conjunction with the conversion shift amount within a range in which the convergence distance adjustment amount does not exceed the predetermined upper limit value.

5. The virtual image display device according to claim 4, wherein
the control device is configured to perform a correction of canceling the distortion related to the virtual image by coordinate conversion using a conversion formula including an original coordinate position and a coefficient, and change the coefficient of the conversion formula according to a change in the conversion shift amount.

6. The virtual image display device according to claim 5, wherein
the conversion shift amount is changed in units of one pixel or in units of a plurality of pixels.

7. The virtual image display device according to claim 5, wherein
the control device is configured to perform gradation adjustment at a pixel point of the display element by interpolation from the pixel point after the coordinate conversion.

8. The virtual image display device according to claim 1, wherein
the control device is configured to correct a distortion in a first direction corresponding to a horizontal direction, and correct a distortion in a second direction different from the first direction of the virtual image by the optical member and the reflection member.

9. A head-mounted display apparatus, comprising:
a first device including the virtual image display device according to claim 1; and
a second device including the virtual image display device according to claim 1, wherein
a convergence distance adjustment amount of the first device and a convergence distance adjustment amount of the second device are the same in magnitude and opposite in direction.
